(19) United States
(12) Patent Application Publication
(10) Pub. No.: US 2005/0257192 A1
(43) Pub. Date: Nov. 17, 2005

(54) Method and device for generating software with customized execution and upgradable without computer programming

(76) Inventors: Yvonne Auberlet de Chelle, Sceaux (FR); Agnes Delle-Vedove, Fontenay Aux Roses (FR); Serge Delle-Vedove, Fontenay Aux Roses (FR)

Correspondence Address: YOUNG & THOMPSON, 745 SOUTH 23RD STREET, 2ND FLOOR, ARLINGTON, VA, 22202, US

(21) Appl. No.: 10/509,992

(22) PCT Filed: Apr. 2, 2003
(86) PCT No.: PCT/FR03/01019

§ 371 Date: Jun. 21, 2005

(30) Foreign Application Priority Data
Apr. 5, 2002 (FR) 02/04235

(51) Int. Cl. G06F 9/44

(52) U.S. Cl. 717/108

(57) ABSTRACT

The invention concerns a method for generating applicative software for management of a process using a system software common to all the applicative software. It comprises: a step of representing the process (32), using a very small number of classes of actions or generic objects, typically less than twenty, in at least a diagram of the application, a step of transcribing (33) each object of each diagram into an action corresponding to an object provided with attributes, each class of action or generic object being, during the transcription step, associated with an application data input interface; a step of transcribing the nodes, branches and end-nodes (34) of each diagram into an action corresponding to an object provided with attributes, a step of pre-compiling (35) which consists in verifying whether the attributes of the objects required for the application operational logic exist and are properly supplied, in syntax; a compilation (36) which consists in integrating and assembling the data specifications of the objects provided with attributes with the system software, to obtain an executable applicative software; and a step of executing (37) the executable applicative software.

The object of this invention is a method and a device for generating customized and upgradeable executable software without computer programming. Said method is used in particular for generating management and control software for a profit center.

The currently known process for generating software is based on the negotiation of a set of requirements between the customer and the computer specialist who is responsible for producing a computer application that meets said requirements, whereby the computer specialist then programs a piece of software in accordance with the negotiated requirements. Since the customer is not familiar with the details of the technical constraints surrounding the work of the computer specialist, the negotiation is unbalanced and itself creates dissatisfaction on the part of the customer. Moreover, any later change to the software requires additional work on the part of the computer specialist, thereby hampering the upgrading of said software.

The goal of this invention is to eliminate these drawbacks. In particular, the goal of this invention is to avoid having a computer specialist program or modify the software. In other words, the goal of this invention is to give the customer the following:
an understanding of the operational process of the generation of the application;
the ability to avoid having the application be subject to the basic models provided by the computer specialists;
the ability to produce, with in a few minutes, a customized computer application that overall meets his needs without having to master a machine language.

In one respect, the object of this invention is a method for generating application software for managing a process, characterized by the fact that said method employs system software that is common to all application software and by the fact that said method includes:
a process representation stage, which uses a very small number of classes of actions or generic objects, typically less than 20, in at least one diagram of the application;
a stage for transcribing each object of each diagram into an action corresponding to an attributed object, whereby during the transcription stage each class of action or generic object is associated with an application data capture interface;
a stage for transcribing the nodes, branches, and leaves of each diagram into an action that corresponds to an attributed object;
a precompilation stage during which it is verified that the attributes of the objects that are required for the operating logic of the application exist and are appropriately formulated in terms of syntax;
a compilation stage during which the data descriptors of the attributed objects are integrated and are assembled with the system software in order to produce a piece of executable application software, and
a stage for execution of the executable application software.

Thanks to these features, the customer creates a representation of the process corresponding to the application by means of a simple graphic representation in the form of a diagram, which defines the whole of the computer application that he wishes to have, with no constraint other than that of having to be familiar with the very small number of generic objects that are to be used. As soon as this phase is completed, the transcription can be done by means of a simple capture process, which can be done by a person with little training. The other two stages, precompilation and compilation, are completely automatic.

Notice that it is easy to make changes or additions to the application descriptors: recompilation provides an updated executable that is compatible with the other versions and can be upgraded with in a few minutes.

Note that assembling a certain number of standard actions into a diagram provides results that are easier to check than code (for example, “C” code) that is generated directly. The principle is that actions that run on appropriately organized data can be considered reliable and their contents can always be traced, thereby avoiding long debugging phases.

The sequences of events in these diagrams are permanently fixed in standard procedures. It is necessary to provide only the identifiers of the screens and files used, and these diagrams will display them, modify the menus as the stages progress, etc. The mechanism of the procedure is always the same, but its content is adapted, in a customized way, to the requirements stated by the users. Of course, there are still a certain number of entry points for introducing actions that are specific to each customer, for example, if the way in which the data are read is very specific (for instance, if the file is not a standard file but rather is imported from another system, the way in which the first file is read is not standard and therefore should be supplied by the designer). However, the fact that there exists a choice of requesting the first file remains standard, and therefore the diagram in question is usable. The overall set of information that is specific to each of the applications is combined in a structured manner into “cards”: the designer “wires” a card to adapt the standard process to each particular process.

This principle makes it possible, for example, for a single visualization action to display different screens depending on the card in which it is located, while at the same time keeping the same call parameters. It is necessary only to have first modified a table of indexed parameters.

This kind of interpretation is done not by the action itself, but rather by the mechanism for interpreting the diagrams (the “wiring” of the card). In other words, an action contains data that are either described in a specific manner or are described by parameters (card+number of the card).

According to specific characteristics, during the object transcription stage at least one action triggers a complete processing cycle that is at a remote location of a tree structure that corresponds to said at least one diagram and, once said processing cycle is completed, returns to its starting point.

Owing to these features, the diagrams can be created, changed, and updated independently.

According to particular characteristics, during the execution stage the executable application software implements a library for managing the sequence of events corresponding to the above-mentioned at least one diagram, whereby said library constitutes an automaton that manages the sequences of events of the processes and executes the operations that checkpoint them, whereby the method ensures that the sequences of events of the operations are defined in the application referential by describing the actual data flows.

Thus, simply implementing the method and the transcription makes it possible to program an application.

According to particular characteristics, during the compilation stage or the execution stage, the method implements an engine that includes an executive that is responsible for recognizing the hardware and communication configuration.

Owing to these features, it is not necessary to generate the configuration in the application. The management of the exchanges is done by tasks on an entire screen, in certain fields, or by means of messages that are sent to the user by the sequence of events in the process.

According to particular characteristics, the engine manages one or more databases according to a data file descriptor that is provided by the application referential, that is, a list of the information contained in each file and the list of the access indices, whereby a list of the fields constitutes each of these indices, the links between the multiple encodings of a single item in multiple services, at multiple sites, or at multiple companies.

According to particular characteristics, the databases are synchronized according to a schedule that is determined by the diagram, upon demand, or before certain predefined events.

Thus, the databases can be synchronized every night, when a user authorizes the request, or for an event that requires it, for example, to create a customer quotation (whereby the stocks and instantaneous prices, for example, must be known for this operation).

According to particular characteristics, to program each action the object transcription stage includes the following:
a naming stage, during which a name is given to said action;
a function definition stage, during which said action is made to correspond to a task, and,
an information definition stage, during which the information that will be processed in the action is designated.

The actions are concatenated according to their functional order in the diagrams. The actions all come down to defined codes; it is thus possible to represent the classic checking structures such as branch, loop, test, etc. . . . These checks themselves are carried out by means of actions.

According to particular characteristics, during the naming stage the compilation stage replaces, by means of the transcriber, the given action name with an index in a task table.

Owing to these features, the transcription stage can be fairly intuitive, whereby the transcriber selects an action name that seems readily recognizable to him, thereby allowing for the automatic and efficient operation of the compiled application.

Other advantages, goals, and characteristics of this invention will become clear from the description given below, which refers to the attached drawings, where:

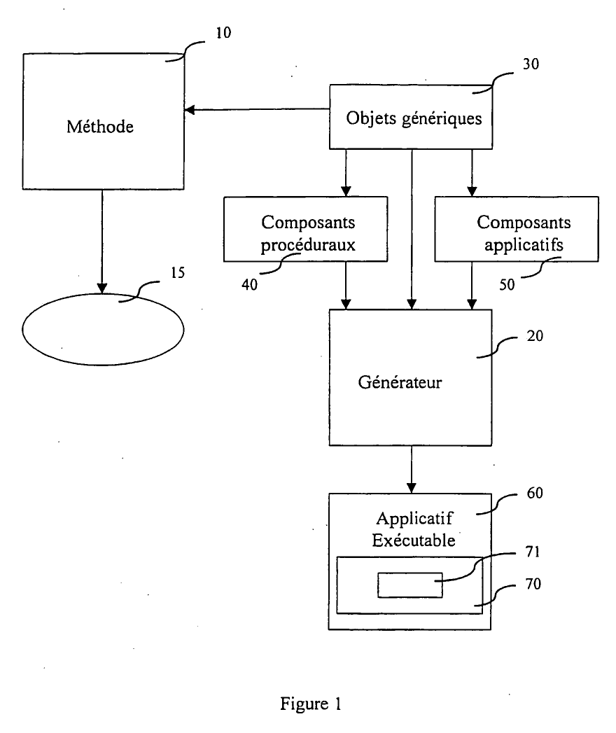

FIG. 1 shows in schematic form the components of the system that is the subject of this invention;

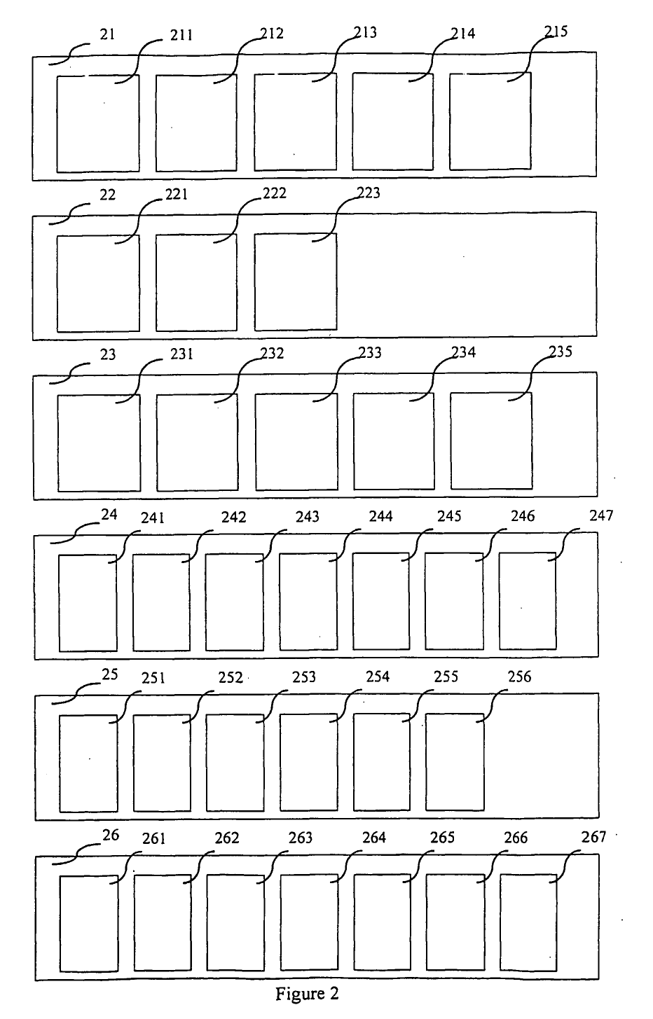

FIG. 2 shows in schematic form the components that are used by the method that is the subject of this invention; and

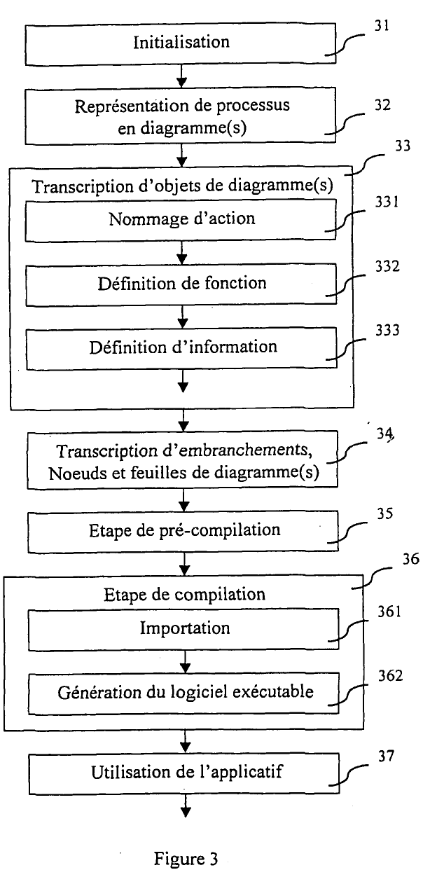

FIG. 3 shows in schematic form the stages that are used by the method that is the subject of this invention.

FIG. 1 shows a method 10 for describing a process and generating a diagram 150, a computer application generator 20 that utilizes generic objects 30, procedural components 40, and application components 50 to generate an executable software 60 that includes an automaton 70 that utilizes the application components 50.

According to method 10, which is a method for cybernetically describing processes, regardless of their nature, for the purpose of producing a descriptor in the form of a macro language, referred to as an “application referential”, the customer first defines his process in large blocks by describing their relationships (for example, management of stocks, accounting, work organization decisions, order-taking, necessary notifications, . . . ). Then, each block is considered and broken down into sub-blocks of tasks, and so on until all of the actions of the process are described using only diagrams that are composed of actions, whereby each action corresponds to a generic object of one of the following attributed classes that is required for the operation of the diagrams:
a) structured interim storage of data;
b) data transmission;
c) supervision;
d) communication with the users;
e) running of the process;
f) operational system (data and signal pickups, issuing of messages and notifications);
g) two-level control (projected or operational).

The macro language defined by method 10 describes the processes for creating a logic layer on top of the computer program layer. Based on the creation of this macro language, a typology was created of the computer processing that is done.

Note that the diagram itself is composed of a root, branches, nodes, and leaves, whereby each of these components is also represented by an action.

With this method 10, the customer defines the bounds of the problem/process for which he wishes to employ a customized executable software program and its relationships with the environment. He can introduce into it exactly what the various people at the profit center do, the anticipated exceptional events (for example, employee vacations, maintenance shutdowns of a machine), and random events (for example, an urgent order or a machine failure) that he wishes to take into account and the notification decision criteria for which he wishes to provide.

In order to determine the above-mentioned typology, the repetitive operations that are carried out during the running of a computer application were inventoried:
these operations are identical, regardless of the issue in question; they are limited in number;
they can be broken down into seven classes (classes “a” to “g” above).

Each of the seven classes of operations is treated according to an “object”-oriented approach by encapsulating the internal rules that are specific to the class, rules that are of a specified repetitive nature and deal with the behavior of computer objects (in contrast to the objects in the application areas of management, which are subject to randomness). The characteristics that are specific to each class and are necessary in order to make the internal rules operate have been inventoried and combined into attribute “structures”, whereby the term “structure” is meant as it is used in computer processing.

Thus, in a second stage the diagrams that represent the running of the management or control process are captured by using capture screens that guide the operator and keep him from making certain incorrect or incomplete captures. Each object is given certain attributes that define the data in predetermined formats (data types, quantity, length, and unit), data storage elements (in permanent files and/or with a date of validity), the access rights of the different users and interfaces that they will use, and decision-making elements with a comparison of options (decision: whether to buy or make, for example). A digital medium makes it possible to represent an application by filling in the attribute fields and the structures that are associated with each object class (for example, a screen is completely defined in two structures that describe the entire screen and each field on the screen).

The generator 20 carries out the following operations:
it verifies the syntax;
it verifies that the necessary information exists;
it generates the database for the application; and
it compiles the executable to provide a customized application.

The generator 20 carries out a precompilation step that verifies that the attributes required for the operating logic of the application exist and are appropriately filled in (in terms of syntax, not of content).

Each action is associated with a capture interface. This particular feature is one of the aspects of this invention. The compilation then ensures the integration of the application data descriptors and assembles them with the system software in order to create an executable. The system software is permanent and is common to all of the applications.

The automaton 70 contains an engine 71 and implements functionalities. The engine 71 represents the order in which the functionalities are implemented and the procedures corresponding to the flow diagrams of the computer application. The engine 71 connects each action to one of its typical tasks 30 (there are 60 of them) by means of execution mechanisms that are broken down into seven classes.

The engine 71 has a predetermined and permanent set of computer-programmed tasks that are efficient and monitored and are called in application actions. These actions are carried out by the core of the engine 71 in an order that is defined in diagrams that are organized in the form of branches, with a mechanism for monitoring the return of the tasks leading to the continuation of the current diagram or to a branch leading to another diagram or another sub-process. For example, a calculation task is continued on to the next task in the current diagram, while a comparison task generally leads to a branch that is defined by the description of the action that calls the comparison task.

Note that the application descriptors can be modified or supplemented: a new compilation provides an updated executable that is compatible with the other versions and is upgradeable. If, however, the descriptor of a data format is changed, it is necessary to transfer the data into a new file, with the new format, whereby this transfer is accomplished by an automatic procedure that is part of the procedural components 40. However, it is possible to add fields within the limits of the space available in the file or to increase the dimensions of the file with the above-mentioned automatic procedure.

With this invention, a procedural description is converted into an executable without a single line of machine language. According to one of its aspects, this invention defines a macro language and/or a new system layer.

It is easy to see that, when the customer wishes to make a modification, the schema of the diagram is modified and, after processing, he obtains a new executable without needing to call upon the skills of a computer specialist.

In the known software, the flow of the exchanges between the software and the users is conducted via the graphical system. Here, it is the software that controls the flow of the operations, including the graphical system. This ensures independence with respect to external systems and the ability to communicate with different interfaces equally by identifying the other party involved.

The engine 71 carries out the operations of the process in a neutral manner, and does so regardless of the field of application, thanks to execution mechanisms that are the result of a rigorous typology of the operating modes of computer science and are divided into seven classes.

Note that, of the 12 structures utilized (structure in the computer sense of the term), three are dynamic structures, one is a navigation structure, and the others are structures that describe data.

Application procedural objects that are repetitive and are common to all kinds of applications are used: capture of a single file, capture of a file with an attached list (for example, the movements of stocks for a product), printing, notification, reconfiguration of data files, and links to other information systems. Attached thereto are a run mechanism and an executive that constitute the “core” of the engine 71.

Other objects will now be described that are implemented in accordance with this invention.

1/The data (or “rubrics”)
name of the datum;
alphanumeric type, number;
size;
justification;
number of decimal places and sign (if the datum is numeric).

Note that a rubric is defined once for an application and can be called in any file or interface of this application. A rubric has the same name in all applications, but its description is adapted to the needs of each application: the files, interfaces, and kinds of processing automatically have the specifications that are particular to the application.

2/The data files (or tables):
the number of data in the file or the amount of space on disk or in memory for managing each file;
the description of the data of each registration of the file and their links to data in other files or on other screens
   name of the rubric,
   links to other files or screens.

3/The user interfaces (screens)
the number of data on the screen and the amount of space for screen management;
the description of each datum in the screen file, its behavior in the exchanges through the man-machine interface, and its links to data in other files or on other screens:
   name of the rubric,
   links to other files or screens
   kind of man-machine interface: designation, text, radio buttons, . . .
   position on the screen,
   capture mode: key creation mode (way in which the file is accessed, for example, by name or by location) or selection mode, current mode (in which a key is no longer modified unless it is modifiable),
   datum-linked types of processing, at the beginning and end of capture (at the end of a check, at the end of processing, . . . ),
   field to return to in case of error.

4/The dynamic management areas of the files and screens when they are being used:
dimensions of the spaces;
values of the data in the file or on the screen while in use (identification of the data, quantities, amounts, . . . );
the status of the processing (phases of file search, processing of the file, file validation).

5/A navigator which, for each user, tracks the path followed during the course of his work and supports hyper-navigation by offering the ability to reach remote processes directly and then return to the current process:
stages of the path;
work done during the stage, with tracking of the links to the remote processes, controlled by an automatic return mechanism.

6/Flow diagrams
description of processing diagrams, with branches either selected by the user (for example, by using menus) or imposed by the logic of the context (switching to two different calculation processes for the price of one return, depending on the nature, purchased or made, of a product);
at each branch, calling processing actions: calculation, assignment of values to data, comparisons, interface with files or screens, . . .

7/Messages and menus
information messages;
alert messages;
selection of types of processing using menus.

In general, the purpose of this invention is to create a composite software system that brings together:
1/An engine 71 that is able to accomplish the following, in a standard way and in real time:
   procedures for processing information of all kinds, either by stimulating future hypotheses or by putting the actual events into play;
   in the form of the sets and subsets of processing that are coordinated and have the ability to provide feedback loops, supplying and/or exchanging information in return;
   while providing permanent control panels and triggering alert signals that are presented to the appropriate users instantaneously or within enough time to allow them to respond (who should be alerted, and when, are thus defined in the diagram).
2/An application referential that is created by means of the method 10, that describes the information and the specific processing thereof, and that precisely meets the requirements of the business and the users:
   for a management process, or a set of interrelated processes;
   in the form of a system and subsystems, with feedback loops;
   with a description, in everyday language and not computer jargon, of the actual data flows, if necessary arranged so as to ensure better performance and improved reaction capacity on the part of the people involved and the system as a whole.
3/A generator 20 of for creating a customized executable piece of software:
   the executable piece of software is generated without programming by bringing together the engine 71 (Paragraph 1) and the referential (Paragraph 2) of the application,
   the customized description of the requirements expressed in the referential is automatically translated into the language of engine 71,
   the executable-software generator itself is built by the standard engine 71 with its own application referential.

In further detail, the engine 71 is a set of libraries of C, Java, and Internet functions that make it possible to manage processes, be they simple or complex, with:
real-time processing of the events and the information that is linked to them;
the detection of anomalous situations, tracked by a system for signaling alerts;
the complete identification of the events, with the data being stored in the form of a continuously updated knowledge base.

Each library specializes in a particular field and is linked to the others in a functional relationship schema. The functionalities and data used in each library are formalized in a language and with a syntax that is specific to the engine 71.

The library for managing the flow of the processes constitutes the automaton 70, which manages the flow of the processes and executes the operations that checkpoint them. The sequence of the operations is defined in the application referential with the help of the method 10 by describing the actual data flows, if necessary arranged so as to ensure better performance and improved reaction capacity, starting at the stage of design, whereby the data flows can be readily adapted when the organization changes over time.

The processes are structured in the form of tree structures of operational data flows. These tree structures represent the actual data flows as they have been analyzed in consultation with the users with the help of method 10. The engine 71 ensures the concatenation of the operations at each branch of the data flow during the course of processing.

Branchs are triggered:
either when the user makes a selection by means of a menu,
or by evaluating the situation that influences the subsequent stages:
   selection of one branch from among several to continue the process,
   implementation of alert signals and feedback loops (control).

Each process is checkpointed by operations or actions. The engine 71 carries out the set of these actions by calling a task library.

The tasks used, which are shown in FIG. 2 and are connected to the sequences of events of the actual data flows, are of five kinds:
a) complex tasks 21 involving calls to other processes or sub-processes;
b) complex switching tasks 22;
c) simple tasks 23 involving calculations and processing of information;
d) tasks involving communication and exchange 24 with the users;
e) transaction tasks 25 with databases.

Each of these five types will be described below.
a) complex tasks 211 involving calls to other processes or sub-processes
   these tasks launch applications in the form of a process name, where each process is controlled by access rights;
   every individual having an access code receives:
      the allocation of a starting process by means of which he enters the system,
      a definition of his rights that control his accesses to other processes during the course of navigation,
   the processes that call tasks make it possible either to access common functional “building blocks” or to “hyper-navigate” between different functions and processes;
      the branch-off to another process ends with an automatic return to the process underway (hyper-navigation);
   the “process call tasks” make it very simple and flexible to use processes in combination and to initiate four kinds of processes:
      a sub-process 211 that follows the process underway;
      a remote process 212;
      a standard sub-process 213 that is common to multiple processes;
      a complex generic application 214 that is common to all the transactions with the users.

A sub-process 211 is triggered by a switch that results from a user selection made through a menu (the sub-process has the name of the original process, plus the number of the item selected from the menu) or an evaluation of the situation (the application referential can either give a specific name to the sub-process or can retain the name of the original process and add to it a letter (for example, an “e” in the case where an error is detected and processed).

For a remote process 212, the user does not have to pick his way through a series of menus. The user directly accesses associated tasks by means of “hyper-navigation”. When a remote process 212 ends, the navigator goes back to the process that issued the call. This remote-process mechanism makes it easy to share one process among multiple users, services, or functions. For example, order-taking can be done by a business that is located far away or nearby, as well as by a local sales management service.

A standard sub-process 213 corresponds to an elementary, entirely repetitive procedure that is common to multiple processes. These standard processes 213 can be defined for a business, taking into account its particular requirements, or for a set of businesses that are subject to the same logic or basic rules. For example, a calculation of actual or anticipated stock can be done at the warehouse, at the time of sales, in an automatic calculation of stock departures, or during an adjustment of inventory.

A complex generic application 214 is common to all of the transactions carried out by the users. This application is part of the functionalities offered by the process that is the object of invention:
simple capture, for example, capture or updating of a customer file or a product file;
list capture, for example, capture or updating of a nomenclature list (list of the components associated with a nomenclature);
the triggering of a notification during the control process, for example, when a deadline passes or when there is an abnormal discrepancy between the budget forecast and actual budget;
printing, for example, the printing of certain customer data: a customer, the category of customers, the entire customer file (list of customers with their addresses or their sales figures, their current orders, . . . ).

Complex switching tasks 22. At each node of the tree structure, switching between multiple branches is triggered in three ways: a user selection 221, navigation using a menu, the identification of a specific situation 222 that includes several processing options (for example, in calculating the sales price of a product based on its nomenclature, the calculations of the cost of a product purchased and that of a product that is manufactured are different and give rise to different sub-processes), or a situation evaluation 223 on the basis of check criteria whereby notifications or feedback loops are triggered (for example, abnormal costs or deadlines).

The simple calculation or information-processing tasks 23 are characterized by the fact that only they process the information directly. The method of the invention includes the information that is helpful for directing and controlling the data flow and ensures control and support in operational decision-making. The device uses the pickups and monitoring rules closest to the events. The process collects in real time the information starting at the time when an event occurs and, as needed, triggers alert signals that are sent to the individuals responsible for operational decision-making with enough lead time (as defined by the diagram) to meet the needs of each of them (immediate for execution decisions or with a delay that is appropriate to ensure efficient management decision-making).

Calculations 231 include basic operations taking into account the number of decimal places, running totals and allocations, and the assignment of alphabetical or numerical values.

Comparisons 232 are made between alphabetical or numerical data. Depending on the results of a comparison, appropriate processing branches are triggered.

Message-dispatch 233 is done to the user or to other users (alerts) depending on the results obtained at a particular location.

Transfers 234 refer to the links between the fields of a screen or between a file and the fields of other screens or files during either importation or exportation. Point transfers can also be done between fields of origin and destination fields.

The processing of dates 235 pertains to the assignment of the “system” date and time, the calculation of the start and finishing dates of operations according to a due date, or the calculation of a due date based on the start and finishing dates and a comparison of said dates.

The tasks involving communication and exchange 24 with the users are carried out through a computer terminal, either through a classic network or by means of an Internet browser. The engine 71 include an executive that is responsible for recognizing the user's hardware and communication configuration (local area network, intranet, Internet, . . . ), and there is thus no need to generate this configuration in the application. The management of the exchanges is done by means of tasks over the entire screen, by means of inserted fields, or by means of messages that are sent to the user by the sequence of events of the process.

The communication and exchange tasks 24 include:
the creation and destruction of a screen (screen activation and memory allocation) 241;
the display of a complete page 242, with its title, designations, and information fields, and then the erasure of the page;
the display of information in fields 243 and screen modification, including the display of the overall set of information (for example, when a file is read), displaying modified fields (for example, after calculations are made that are triggered by the capture of a field and that influence other fields, the assignment of a value to a radio button, . . . );
the management of modification authorizations 244, with regard to the components of the codes or names that ensure the reading of files in the database (access in the selection mode, modifiable or non-modifiable key fields), or the current information on a screen page (access in the update mode, read-only access, or a field without a contextual object);
the particular position in a field 245, including a required field and fields that are to be corrected in the case of a recognized capture error;
the sending of a message 246, including sending information to the user, especially in the event of an error, the display of a dialog box that has to be acknowledged before the screen capture is taken up again, or the display of a persistent information message at the bottom of the screen;
the erasure of the screen 247, including temporarily switching to another screen and, when finished with a screen, before it is destroyed.

Note that the design of the screens is adapted to each category of users based on each user's requirements. A simple description of them in the application referential is sufficient to support the exchange management tasks mentioned above. They can be quickly and easily adapted as needed, simply by modifying their descriptor. The information is presented in the form of graphical objects that are specified as such (regular capture field, “database” buttons, vertical or horizontal radio buttons, checkboxes, tabs, editor, table, barcode, designation, hyperlink). The information fields are accessible for updating, accessible in a read-only mode or are hidden at the destination, for example, identifier fields, intermediate calculation fields, or information fields that are processed at the destination on remotely located control panels.

As regards access privileges, any access to the processes is contingent on a check of the privileges of the person on line. Anyone accessing the application is allowed to “see” or make modifications only if he is allowed do so based on the privileges that he has received with his access code. The privileges may change over time, as determined by an access administrator. For a person who has elevated privileges, it is important to receive several access codes with multi-level privileges in order to limit the risks of others gaining improper access to confidential information.

The presentation of the print documents is considered to be the screen display, limited to read-only, with the option of having larger “page” sizes.

The database transaction tasks 25 include:
the initialization and freeing up of information areas linked to a file 251;
the creation or updating of files 252 by writing to the destination database (each file automatically receives a unique identification number, whereby code or call modifications have no effect);
the creation of access keys for reading a particular file 253: access can be controlled by means of codes, names, periods of validity, links to other files, . . . (access to the multi-coded database makes it possible to make the information available to each category of users in accordance with the constraints of his particular culture, for example, product codes are frequently different for the technical and the commercial realms or between multiple companies or between multiple independent processes (for example, links between the different services provided by a bank to the same customer);
the reading of a file 254 (the file is read based on one or more access codes that are to be specified: code, name, identifier, . . . );
the reading of the list of files having a common attachment 255 (for example, the movements of stocks associated with a product, the components of a product, order lines, list of current orders for a customer, list of orders for product);
the suppression of a file 256, according to predetermined controlled modalities (for example, not suppressing a product file if said file has a stock or if a current order line is associated therewith);
running through a file to conduct systematic processing of all files, on a set of files between two boundaries, or on files having the same root (for example, printing of all or part of a file, working up of margins on all orders from one customer, one business agent, one region . . . ).

The engine 71 manages the database(s) based on the data file descriptor given by the application referential, i.e., the list of the information contained in each file and the list of the access indices, along with the list of fields used to construct each of these indices, the links between the multiple encodings of the same item and multiple services (business and technical), multiple sites, or multiple businesses (customers-suppliers, merged companies, . . . ), whereby the databases are then synchronized on a specified schedule that is determined by the diagram or upon request or in advance of certain events (for example, in order to provide a customer quote).

Regarding the updating of the application referential over time, note that, within certain size limits of each file, which are monitored by the engine 71, it is possible to add to the information contained in a file. If the formats of the information used in the company change over time, it is easy to keep the data collected in the past updated using a system procedure of the engine 71.

The link library 26 is shared between the application referential and the engine 71. The information required for the execution of the tasks should be specified with regard to requirements, and the engine associates them with seven types:
a) menus and selections 261,
b) messages and alerts 262,
c) information fields and data format 263,
d) information designations 264,
e) files 265,
f) visual interfaces 266, screens, or Internet pages
g) process branches and tasks 267.

Selection menus 261. The switching tasks initiated by the users contain “menus and selections” information. The users are presented with a menu whenever they are required to intervene in order to choose among multiple sub-processes and continue navigating. The method refers to each of the elements of the menu as a “selection”. A branch of the process is linked to each selection. Each of the branches has an access code: if the user does not have the necessary privileges, the menu imposes a filter and does not offer the corresponding selection.

Messages and alerts 262. The method uses the term “messages” to refer to the exchanges that are triggered during transactions with a user. The method sends information messages exclusively to the user to facilitate this task and sends anomaly and error messages when anomalies and errors are detected. The method uses the term “alert” to refer to the sending of control information to all users involved whenever the method detects anomalies during the course of a process. The remotely dispatched alerts are different in nature than the messages and are associated with the standard alert management procedure. The tasks involved in exchanges and communications with the users are carried out in real time.

Information fields 263. Each element of an information list in a file and in a visual interface is referred to as a “field”. For the fields of a file, the format specification for each item of information indicates the size of the information and consequently reserves the amount of space needed to store said information on disk. When the software is generated, the database is automatically created or updated. For the fields on a screen, an Internet page, or a printout, the information can be presented in response to a user request and can easily be changed.

Each field has a name and a format. Each company uses a set of basic data: technical and business references, unit prices, the amount of an invoice, times, costs, the delivery time of an order, sales volume plus taxes and sales volume with all taxes included, . . .

The method uses the term “data format” to refer to the specification of the format of each of these data. This data format is used to reserve the necessary space in the files, to display the information correctly, and to monitor the capture of the information. The assignment of a format to an item of information specifies its presentation and its size: attribute (alphanumeric data, numerical code, number, date, . . . ), description (character number, justification, any sign that may be present, number of figures in the integers section and number of decimal places, number of month—less than or equal to 12, number of week—less than or equal to 54, date of the month—less than or equal to 31, hour of the day—less than or equal to 24, . . .

The method manages a multiple encoding scheme (multi-encoding) to take into account different references for the same object, for example, technical and business references, links between different processes, different references for multiple sites or companies belonging to the same group, or for multiple companies having economic ties (customers-suppliers, merged companies, . . . ).

Information designation 264. The method makes identifications by designating the information presented on the media for communications with the users. Each item of information on an interface is presented with a designation. Multiple designations can be used to take into account differences in the users' languages or duties.

Files 265. The method defines the structure of the information in the files and the organization of their storage in a database. The files bring together the sets of structured data. A record is a file structure (for example, a customer record) that contains a list of data that are defined by a name and a format. Each record in a file can be accessed by several different access keys depending on the user's interests or his needs of the moment. The events are identified in real time with labels that are appropriate to the situation in question. The database is a continuously updated knowledge base.

Visual interfaces 266, screens, or Internet pages. The method defines the way in which the data are organized to be presented to the users. The visual interfaces represent a set of information that is displayed with their designations on a computer screen, an Internet page, or a printout. As in the case of the files, a visual interface includes a list of data that are defined by a name and a format, as well as being linked to the corresponding data that are stored in the files. Each item of information is furnished with attributes that determine their visual presentation, or their method of processing or capture. The visual interfaces can be presented in a form that is suitable for each user and can be modified for new users or to meet new requirements.

Process branches and tasks 267. Each process branch is represented in a diagram and reflects the description of the actual data flows, whereby said description is produced by the application referential: name of the process, concatenation of the operations, branching nodes, access rights to the process (services, approved items). Each of the operations should be described: name of the operation, name of the task of the engine 71 that is to be executed, and the parameters of the operation, all according to the syntax determined for each of the existing tasks.

The Application Referential.

This referential is created in coordination with the users involved in the process that is to be automated, according to the existing situation and by studying possible improvements that can be facilitated by the use of a computer tool. Once the users' concurrence is obtained, the referential is digitized (for example, by capture or by optical or audio reading) so as to ensure automatic importation into the executable software.

Customized-executable-software generator 20. This generator uses the data of the application referential as transcribed into digital form. The generator 20 operates in two stages:
importation 361 (see FIG. 3) of the data of the referential into an internal database; and
generation 362 (see FIG. 3) of the executable software.

Note that in FIG. 3 the use of a particular embodiment of the method that is the subject of this invention involves the use of a system software that is common to all the software, and:
an initialization stage 31 of a computer system;
a process representation stage 32 that implements a very small number of classes of actions or generic objects, typically less than 20, in at least one diagram of the application;
a stage 33 for transcribing each object of each diagram into an action corresponding to an attributed object, whereby each class of action or generic object is associated with an application data capture interface that includes the following, for programming each action:
i) a naming stage 331 during which a name is given to said action;
ii) a function definition stage 332, during which said action is identified with a task; and
iii) an information definition stage 333, during which the information that will be processed in the action is identified.
   a stage 34 for transcribing the nodes, branches, and leaves of each diagram into an action corresponding to an attributed object;
   a precompilation stage 35, during which it is verified that the object attributes required for the operating logic of the application are present and are supplied in a way that is syntactically appropriate;
   a compilation stage 36, during which the data descriptors of the attributed object are integrated and are assembled with the system software to produce a piece of executable application software; and
   a stage 37 for execution of the executable application software that is compiled during the compilation stage 36.

During the object transcription phase, one or more action(s) launch(es) a complete processing process that is located away from a tree structure that corresponds to said at least one diagram and, once said process is completed, returns to its starting point.

During the execution stage, the executable application software preferably implements a library for management of the running of the process corresponding to said at least one diagram, whereby said library constitutes an automaton 70 that manages the running of the processes and executes the operations that checkpoint them, whereby the sequence of events in the operations is defined, in the application referential, by means of the method 10 by describing the actual data flows.

During the compilation stage or the execution stage, the method preferably implements the engine 71 that includes an executive that is responsible for recognizing the hardware and communication configuration. The engine 71 preferably manages one or more databases according to a data file descriptor that is provided by the application referential, i.e., a list of the information that is contained in each record and a list of the accessed indices, whereby a list of the fields serves to constitute each of these indices, which are the links between the multiple encodings of the same item in multiple services, at multiple sites, or at multiple businesses. The databases are synchronized according to a schedule that is determined by the diagram, on demand, or before certain pre-identified events.

The compilation stage (36) preferably replaces the action name that is given by the transcriber during the naming stage 33 with an index in a task table.

During the representation and transcription stages, said at least one diagram preferably corresponds to at least one tree structure in which the nodes and leaves, where the code is implemented, are made up of actions, whereby the return values of these actions determine the movement in the tree structure.

Once generation is completed, the process can move on to the enterprise application, whereby each process of the business is accessible based on the users' access privileges.

The application referential can be modified. Regenerating the executable software makes the new version available to the users. The time it takes for generation to be completed is on the order of 10-30 minutes, depending on the magnitude of the process.

Stage 361 for importing the data of the referential into an internal database. During this phase, the generator 20 checks the syntax and coherency of the data supplied by the application descriptor. A check is made to ensure that certain mandatory description data are present. The data that are called during the processing steps must exist: information fields, designations, messages, processes, and tasks. If the generator 20 detects an error, it sends out a message and refuses to move on to the next phase.

Generation stage 362. Once the application referential is accepted, the generator 20 generates the application software by associating the engine 71 with the application data. The end of this generation 362 phase returns control to the user, whereby the new version is available in the event that changes are made.

Two classes of structures are defined:
those that serve to describe the information used in the application, particularly the format of the data, the structure of the registrations in the database, and the way in which the screens are presented; and
those that correspond to the way in which the program will run (the order in which the processing stages will be carried out): a data-flow or process diagram and actions that will be taken on the data flows.

The former are description data and the latter are run data.

The run data include:
a/The actions

The run data have a particular organization, which has a major impact on the way in which the applications are programmed. One of the reasons for this is to avoid programming directly in machine language for example, in C. For this purpose, a certain number of data manipulation and presentation functions have been defined. With them are associated a certain number of arguments that are fixed or can be parameterized based on certain data structures (the “cards” described below), and the entire unit can be put into a package that is identified by a code. Each element is called an “action”. The action structure is given below:

struct action
{

| char | ″ac_name; |
|---|---|
| int | ″ac_fonc |
| unsigned long ac_param[MPRM]; | |
| char | ″ac_article; |

}

Accordingly, programming an action amounts simply to giving it a name, assigning the “engine task” or “standard task” (for example: calculation, comparison, check, branches, . . . ), and specifying the information that will be processed during the action.

The actions are concatenated in their functional order in diagrams. The actions bring everything down to defined codes, and it is therefore possible to represent the classic check structures such as branch, loop, test, etc. The checks themselves are carried out by actions, see below. Running of the code in the application—Process diagrams.

The concept on which the running is based, which is closely tied to the concept of action, is that of a tree structure. It is not a new idea for a menu-based application to be structured in the form of a tree. In our case, however, the diagram has the particular feature that its nodes and leaves, where the code is carried out, are made up of actions. As a matter of fact, each node is a container where MACT actions can be found—the number of actions in a branch, MACT, is a parameter of engine 71. The return values that are provided by these actions determine the movement in the tree structures.

Note that assembling a certain number of standard actions into diagrams yields a result that it easier to check than that of C code that is generated directly. The principle is that actions that are sent to work on appropriately packaged data are considered reliable and their contents have never been tracked.

Implementation of the Diagrams.

The names of the diagrams and the actions checkpointing the diagrams are put into a structure called struct branche. The branche structure is described below:

typedef struct branche
{

| | |
|---|---|
| char | nom_diagramme[LNOM]; |
| unsigned int | table_traitements[MACT]; |
| char | *securité; |

}node;

The name “nom_diagramme” makes it possible to identify the diagram and to move from diagram to diagram. The elements of table_traitements are actions that will be carried out upon arrival at the diagram; the designer gives them a name, and the compilation replaces these names with indices of the actions in a table that holds them: their access is instantaneous and makes it possible to ensure good machine processing performance.

The character string “securite” is examined before any request to enter the diagram so as to be able to deny access based on the privileges of the application user. This is why certain menus will be hidden from some users but visible to others.

Using an example, a description is given below of how movement is done in the nodes and how the code is executed.

Let us assume that the name of the current diagram is “L”.

Upon arriving in this diagram, the system executes the action tab_tr[0]. If this action brings up the code NEXT, as do, for example, the first four actions of the diagram L11, the next action is executed. If this action brings up DSCD (for “descend”), it must have also set a global variable, Choix. This variable will then be concatenated to the name of the current diagram in order to give the name of the new diagram. For example, if the value of the variable Choix is “1”, the process heads for diagram “L1”. Note DSCD(1), the association of DSCD and choix=1. The inverse of the procedure takes place if the action returns RTME. In this case the action must have set certain internal cloths (“flags”) to determine the action of the ascending branch to which the processing is returned. For example, going back up to action 3 after L1 sets us on the fourth action of node L (whereby the actions are numbered starting at 0).

More specifically, it is the ASCII character that represents the number selected that is added. It is not necessary to avoid giving “Choix” a value that does not fall within the interval [a-zA-Z-0-9] in order to stay away from invisible characters or characters with functionalities in the ASCII table.

It is then possible to move on to an action in the same node, without it necessarily being the next action, by setting NACT plus the number of the action to be accomplished by the branch Choix and returning NACT. Processing continues until an output action is reached whose associated function is to close the files that are still open in the database and to clear the memory spaces.

Note that this does not necessarily mean that we have come back to the root or that we have run through the entire diagram or any other condition of this type. It is also possible to make an “emergency exit” from the application with certain error processing routines that send a message and halt or close the session.

It is understood that, in moving through the menus, the system interprets the keyboard inputs. If a function key (F1 to F9 in the standard version) is depressed, the cursor will immediately move down in the current branch, to which a character between “1” and “9” will be concatenated. It is thus possible to trace the path that has been taken from the start. There also exists a global debugging variable which, when moving through the diagrams, displays the name of the current branch at the bottom of the screen and makes it possible to check that the procedure is running properly and to quickly identify errors made in the numbering of the processes.

If an action sets “Choix” to, for example, “7”, there is no way to know from reading the sources of the diagrams whether the branch that made is reached because of a keyboard input or a processing step. It is recommended that the designer reserve the values of the menu Choix in the range of [1-9] for the branches obtained from a menu and assign alphabetic values to the branches that are automatically triggered by the application context.

Note that if the last action in the diagram brings up the value NEXT, the system will find an error and stop, as is the case if an attempt is made to descend when the user is already on a leaf or if an attempt is made to go up when the user is already at the root.

Launching of Diagrams.

The name of the first diagram that is launched depends on the activity that is desired. It is launched at the end of a main by a call to the diagram interpretation function. Of course, this routine takes the name of the diagram as an argument, but also the number of the action that is executed first. As a matter of fact, it is sometimes desirable not to start at action 0 since the first actions may trigger, for example, undesired initializations. The arguments type_arbre and no_arbre are also given, which will give their values to the variables tp_arb and no_arb. These variables make it possible to determine the kind of diagram, i.e., whether it is a Capture diagram, a List diagram, or a Print diagram, to mention the standard types, or another type if necessary. Since multiple modules can be of the same type (for example, the customer, supplier, and item modules can all be Captures), they are distinguished by a number no_arb. This number depends on the generation of the cards by the generator 3. These variables make it possible to link the personalized parameter tables of a module to a common standard process (see captures of single files or list files, printing, triggering of alerts).

Launching of Specific Diagrams.

Starting from a given action, it is sometimes important to launch the completed processing cycle that is located away from the tree structure and, once this processing cycle is completed, to be back at the starting point. This is made possible by the fact that, even though all of the diagrams of the application are combined in the same table, the table in fact encompasses a forest. It is possible to launch a new tree structure as a link to a “sub-process” or “subsystem” in computer terms by means of the diagram launch action, while “main( )” launches the initial diagram. This is how the different modules are integrated into the application. Use is made of an existing diagram that describes a module; it is given a name and, starting from our original tree structure, the diagram in question is launched. Exiting from the specific diagram is done by an action that brings up ENDA.

Customer Diagrams and Common Diagrams.

The customer diagrams are diagrams that are specific to one application. The common diagrams are “procedural objects” that are permanent and are accessible by calling up cards that identify the jobs to be accomplished and the information necessary to ensure the running of a specific procedure according to a standard model (procedural object): names of the files and screens, names of the menus and messages, processing diagrams to be executed at specific times in the procedure (for example, the end of the selection of a record to be updated). These series of processing cycles will be used in all the applications. For example, the processes of list capture, Captures, printing, etc. are common. In the case of Captures, for example, there is always a menu that proposes a selection such as that given below:
CREATION
MISE A JOUR [update]
CONSULTATION
SUPPRESSION
FIN [end]
   And then, after MISE A JOUR is selected, the following selections are presented, for example:
PREMIER [first]
DERNIER [last]
SELECTION
FIN [end]
   And then, after MISE A JOUR is selected, for example:
PREMIER [first]
DERNIER [last]
SUIVANT [next]
PRECEDENT [previous]
SELECTION
VALIDATION CHOIX [confirmation of selection]
FIN [end]

The running of these diagrams is permanently fixed in standard procedures. It is necessary only to provide the identifiers of the screens and files used, and these diagrams will display them, modify the menus as the stages proceed, etc. . . . The mechanism of the procedure is always the same, but its content is adapted in a customized way to the requirements stated by the users. Of course, a certain number of input points are still left for entering actions that are specific to each customer, for example, if the way in which the data are read is very specific (for example, if the file is not standard file but rather is imported from another system, the way in which the first file will be read is not standard and thus has to be provided by the designer). However, the fact that it is possible to elect to request the first file remains standard, and therefore the diagram in question can be used. All of the information that is specific to each of the applications is combined in a structured way into “cards” (see below): the designer “wires” a card to adapt the standard process to each specific process.

The kinds of treatment that are specific to certain customers and that cannot be generalized are encoded in the form of specific diagrams and actions. These diagrams have exactly the same structure as the standard diagrams but are placed in a secondary table, i.e., they are not compiled with the applications that do not have access thereto. Note that the system's search for the diagram names always begins with the customer diagrams. It is thus possible to define one's own customer diagram and to give it the same name as a common diagram whose behavior one does not need. This is the customer diagram that will be adopted instead. However, it is not possible to request explicitly to use the customer version or the common version of a diagram.

Launching of Additional Actions.

The maximum number of actions in a diagram is sometimes not sufficient to ensure processing. There are several ways to address this kind of problem. It is also possible to launch a specific action that makes it possible to hook back up to a diagram, with a return to the action following the branching action (hyper-navigation).

At each field on the screen, it is possible to trigger diagrams, when entering the field and leaving it (assignment of values, instantaneous calculations, . . . ).

Cards.

Cards are sets of parameters that make it possible to orchestrate the behavior of the diagrams that relate thereto. They bring together the majority of the information that is helpful in managing the various modules that constitute an application, for example, the names of the files concerned, the Capture screens, header and list if need be, the names of the key fields for data read/write, the process monitoring flags, the names of the menus to be displayed at the bottoms of the screens, the specific actions to be launched during the running of the diagrams, etc.

A card is a structure that brings together a certain number of unsigned numerical inputs and a certain number of character strings. We will consider only the case of the numerical data since the description is similar for the cards that pertain to data of the “character” type.

Three types of cards, corresponding to the tree major types of processing, the Capture cards, the List cards, and the Printing cards, are generally distinguished. The differences among the types lie solely in the number and meanings of the inputs in the structure that represents said type.

The identifications of these cards are given by two parameters tp_arb and no_arb, which are known at all times to the processing environment and make it possible to know in which kind of application module the user is working (single capture, list capture, printing, . . . and on what subject: item, stocks, . . . ).

All of the card structures of the given type are combined into a table (there are thus three main tables), and one grouping table, cart[ ], brings together the pointer structures of each table. The order of the different types of cards in this table is as follows:
0 Réservé [reserved]
1 Saisie des listes [list capture]
2 Saisie simple [simple capture]
3 Réservé [reserved]
4 Impressions [printing]
5 Réservé [reserved]

A description is given below of how to reference a parameter in a card. Each datum in a card is identified in the standard actions in the following form: type of parameter (numerical or alphabetic)×1000+the sequence number of the parameter in the descriptor of the card, for example, 58. The kernel of the engine 71 recognizes that the data is coming from the card currently being handled and makes a double indirection to the card of the process under way, i.e., to the 58^{th} position on this card. This processing is automatically carried out by the action executor, thus providing the proper values for these actions. This kind of interpretation is done not by the action itself, but rather by the mechanism for interpreting the diagrams of the kernel of the engine 71.

This principle makes it possible, for example, for a single display action to display different screens depending on the card on which is located, while at the same time keeping the same call parameters. It is necessary only to have modified the indexed-parameter table in advance.

This kind of interpretation is done not by the action itself, but rather by the mechanism for interpreting the diagrams (“wiring” of the card). In other words, an action includes data that are either described specifically or are described by parameters (card+number in the card).

If the fields are key fields, the node can proceed to run tests to verify their validity (the record must exist in the “update” mode and cannot exist in the “creation” mode). The standard capture functions will then move on to all of the fields except for the key fields. After the key is created or a record is selected in the update mode, the procedure moves on to a current capture phase and processes the accessible fields.

Level.

A list of chained structures that are dynamically allocated by the system makes it possible at any time to obtain significant information concerning the current status of the application. These structures, which are called level structures, include in particular:
the name of the current diagram (nom)
the index of the action and current diagram (nact)
the name of the card (tp_arb)
the index of the card in the card table (no_arb).

The system assigns this kind of structure to each descent or each launching of a diagram. The structures are released at the end of the diagram or after going back up.

Transfers, Insertions, and Extractions.

The essence of the processing that is done consists of transfers of information from one zone to another, for example, to a file field after a registration is read to a screen field that makes it possible to display the information in question. The screen/file structures allow up to three transfer encodings. An encoding has an unsigned int (32 bits) and looks as follows:
type of datum (file, screen), name of file or screen, name of field.

1. Method for generating application software for managing a process, characterized by the fact that said method implements a system software that is common to all of the application software and that said method includes:
a process representation stage (32) that implements a very small number of classes of actions or generic objects, typically less than 20, in at least one diagram of the application;
a stage (33) for transcribing each object of each diagram into an action corresponding to an attributed object, whereby during the transcription stage each class of action or generic object is associated with an application data capture interface;
a stage (34) for transcribing the nodes, branches, and leaves of each diagram into an action corresponding to an attributed object;
a precompilation stage (35) during which it is verified that the object attributes required for the operating logic of the application are present and are supplied appropriately in terms of syntax;
a compilation stage (36) during which the data descriptors of the attributed object are integrated and are assembled with the system software to produce an executable application software; and
a stage (37) for execution of the executable application.

2. Method according to claim 1, wherein, during the object transcription stage (33), at least one action launches a complete processing cycle that is located at a remote location of a tree structure that corresponds to at least one diagram and, once said processing cycle is completed, returns to its starting point.

3. Method according to claim 1, wherein, during the execution stage (37) the executable application software implements a library for managing the sequence of events corresponding to the above-mentioned at least one diagram, whereby said library constitutes an automaton (70) that manages the sequence of events of the processes and executes the operations that checkpoint them, whereby the sequences of events of the operations are defined in the application referential, by means of the method (10), by describing the actual data flows.

4. Method according to claim 1, wherein, during the compilation stage (36) or the execution stage (37), the method employs an engine (71) that includes an executive that is responsible for recognizing the hardware and communication configuration.

5. Method according to claim 4, wherein the engine (71) manages one or more databases according to a data file descriptor that is provided by the application referential, that is, a list of the information contained in each file and the list of the access indices, whereby a list of the fields constitutes each of these indices, the links between the multiple encodings of a single item in multiple services, multiple sites, or multiple companies.

6. Method according to claim 5, wherein the databases are synchronized according to a schedule that is determined by the diagram, upon demand, or before certain predefined events.

7. Method according to claim 1, wherein the object transcription stage (33) includes, for programming each action:
i) a naming stage (331) during which a name is given to said action;
ii) a function definition stage (332), during which said action is identified with a task; and
iii) an information definition stage (333) during which the information that will be processed in the action is identified.

8. Method according to claim 7, wherein the compilation stage (36) replaces the action name that is given by the transcriber during the naming stage (331) with an index in a task table.

9. Method according to claim 1, wherein, during the representation stage (31) and transcription stage (32, 33), said at least one diagram corresponds to at least one tree structure in which the nodes and leaves, where the code is implemented, are made up of actions, whereby the return values of these actions determine the movement in the tree structure.
